(19) United States
(12) Patent Application Publication
(10) Pub. No.: US 2011/0072091 A1
(43) Pub. Date: Mar. 24, 2011

(54) AUTOMATED CALENDAR-BASED INSTANT MESSAGING CONTROLS

(75) Inventors: Michael D. Facemire, Pittsboro, NC (US); Thomas R. Haynes, Apex, NC (US); Lin Sun, Morrisville, NC (US); Michael C. Wanderski, Durham, NC (US)

(73) Assignee: INTERNATIONAL BUSINESS MACHINES CORPORATION, Armonk, NY (US)

(21) Appl. No.: 12/565,276

(22) Filed: Sep. 23, 2009

(51) Int. Cl. G06F 15/16; G06F 21/00

(52) U.S. Cl. 709/206; 726/4

(57) ABSTRACT

An instant message addressed to a recipient associated with an instant messaging device is received at the instant messaging device. A configured calendar event for the recipient associated with a time period during which the instant message is received is determined. Authorization information associated with a sender of the instant message is received. The instant message is processed based upon the configured calendar event for the recipient and the authorization information associated with the sender of the instant message.

### BACKGROUND

The present invention relates to instant messaging controls. More particularly, the present invention relates to automated calendar-based instant messaging controls.

Instant messaging systems allow instant messaging device users an ability to send messages in real time or in pseudo real time to other instant messaging device users. A recipient of an instant message receives an indication of a received instant message, typically via a pop-up graphical user interface window, and may respond with a response instant message. The recipient of the response instant message may respond in kind over a course of several messages during an instant messaging session. Instant messaging sessions end when either user does not to respond to an instant message received from another instant messaging device.

### BRIEF SUMMARY

A method includes: receiving, at an instant messaging device, an instant message addressed to a recipient associated with the instant messaging device; determining a configured calendar event for the recipient associated with a time period during which the instant message is received; receiving authorization information associated with a sender of the instant message; and processing the instant message based upon the configured calendar event for the recipient and the authorization information associated with the sender of the instant message.

A system includes: a memory; and a processor programmed to: receive an instant message addressed to a recipient; determine a configured calendar event for the recipient associated with a time period during which the instant message is received; receive authorization information from the memory associated with a sender of the instant message; and process the instant message based upon the configured calendar event for the recipient and the authorization information associated with the sender of the instant message.

A computer program product includes: a computer readable storage medium having computer readable program code embodied therewith, the computer readable program code comprising: computer readable program code configured to receive an instant message addressed to a recipient; computer readable program code configured to determine a configured calendar event for the recipient associated with a time period during which the instant message is received; computer readable program code configured to receive authorization information associated with a sender of the instant message; and computer readable program code configured to process the instant message based upon the configured calendar event for the recipient and the authorization information associated with the sender of the instant message.

### BRIEF DESCRIPTION OF THE SEVERAL VIEWS OF THE DRAWINGS

FIG. 1 is a block diagram of an example of an implementation of a system for automated calendar-based instant messaging controls according to an embodiment of the present subject matter;

FIG. 2 is a block diagram of an example of an implementation of an instant messaging device that is capable of performing automated calendar-based instant messaging controls according to an embodiment of the present subject matter;

FIG. 3 is a flow chart of an example of an implementation of a process for automated calendar-based instant messaging controls according to an embodiment of the present subject matter;

FIG. 4 is a flow chart of an example of an implementation of a process for configuring an instant message account for automated calendar-based instant messaging controls according to an embodiment of the present subject matter; and

FIG. 5 is a flow chart of an example of an implementation of a process for sending an instant message and performing automated calendar-based instant messaging controls in response to automated calendar-based instant messaging controls implemented by the receiving device according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides automated calendar-based instant messaging controls. A user of a computing device with instant messaging capabilities is provided with a capability to correlate calendar information with authorization privileges for users of other computing devices. The user configures calendar events for different purposes and creates authorization privileges for other users with which the user communicates via text messaging. The authorization privileges correlated with the configured calendar events allow the user to limit (e.g., channel) received instant messages from the other users to those configured calendar events during which the other users have been authorized to send instant messages. By use of the present subject matter, the user may stay on task and avoid instant messaging interruptions from other users that are unrelated to a currently-configured calendar event. This allows the user, for example, to complete work in a more efficient manner.

When an instant message is received at an instant messaging device, the instant messaging device determines a configured calendar event for the recipient associated with a time period during which the instant message is received. The instant messaging device may determine the configured calendar event by, for example, querying a calendar application associated with the instant messaging device for a configured calendar event that is scheduled concurrently with the time period the instant message is received. Authorization information associated with a sender of the instant message is retrieved to determine the sender's authorization status with respect to the configured calendar event. For example, the sender may be a colleague associated with a work-related project correlating to the configured calendar event. Alternatively, the sender may be a friend that is curious about an after-work related activity. The instant message is processed based upon the configured calendar event for the recipient and the authorization information associated with the sender of the instant message.

When the authorization information associated with the sender authorizes receipt of the sender's instant messages during the configured calendar event, the instant message may be rendered for viewing by the recipient. In contrast, when the sender is not authorized to send instant messages during the configured calendar event, the instant messaging device may retrieve calendar information associated with the recipient and automatically determine an approved time period during which the sender is authorized to send instant messages to the instant messaging device based upon the recipient's calendar information. The instant messaging device may then send an automated reply instant message to an instant messaging device associated with the sender indicating the approved time period during which the sender is authorized to send instant messages to the instant messaging device.

The instant messaging device may also analyze the calendar information retrieved from the calendar application to determine another preferred time period during which the recipient prefers to receive instant messages from the sender. In such a situation, the automated reply instant message may also include the other preferred time period during which the recipient wishes to receive instant messages from the sender. As such, upon receipt of the automated reply that includes the alternate time period for instant message communication (e.g., when the instant messaging device is the device that originated the instant message that results in an automated reply), the instant messaging device may automatically close an instant message session in response to receipt of the automated reply. The instant messaging device may also automatically create a calendar reminder within the calendar application of the sender's instant messaging device to resend the instant message to the intended recipient during the preferred instant messaging time period.

Additionally, in association with generation of the automated instant message reply, the instant messaging device may determine whether the sender of the received instant message is authorized to receive information associated with the configured calendar event. For example, the sender may be a colleague associated with an unrelated project and the sender may not be authorized by the recipient, such as for confidentiality reasons, to receive information related to the calendared event. Alternatively, the sender/colleague may become concerned if they believe that their project is not receiving attention from the recipient during a given time period. In such situations, the colleague's authorization may be configured via the instant messaging device to block distribution of the configured calendar information in association with the automated reply instant message. In contrast, the sender may be a manager of the recipient and may be authorized to know what the recipient is working on at all times. In such situations, the manager's authorization may be configured via the instant messaging device to distribute the configured calendar information in association with the automated reply.

Regarding determinations for authorization for receipt of instant messages and for receipt of configured calendar event information, the instant messaging device may configure and store a hierarchical list of persons authorized to send instant messages in association with configured calendar events and a hierarchical list of persons authorized to receive calendar information associated with the recipient. The hierarchical lists may further be combined into one hierarchical list, as appropriate for a given implementation. As such, upon receipt of an instant message or in association with an automated reply instant message, the instant messaging device may determine whether the sender is listed within the hierarchical list as a person authorized to either send instant messages during the configured calendar event or receive the calendar information associated with the recipient. The hierarchical list of persons may further be configured with groupings, such as work, recreation, etc., that allow filtering or other processing of instant messages based upon the configured calendar events. As such, processing may include determining whether the sender is a member of a group of instant message senders that are authorized during a given configured calendar event.

In addition to the processing described above, upon determining that retrieved authorization information associated with the sender of the instant message does not include calendar authorization information associated with the sender, the instant messaging device may perform semantic analysis upon text associated with the received instant message. In such a situation, the instant messaging device may derive the authorization information for the sender based upon the semantic analysis of the text associated with the received instant message. As such, the instant messaging device may implement the controls described above in the absence of pre-configured authorization information associated with a sender of an instant message to enhance authorization information. Additionally, the recipient may then be provided with an inquiry and a response may be detected, such as via an input device, to add the sender to an authorized list, such as a hierarchical list as discussed above, for the configured calendar event.

Additional possibilities exist for generation and processing of authorization information for use in controlling instant message interactions in association with configured calendar events. Accordingly, any such additional possibilities are considered within the scope of the present subject matter.

The automated calendar-based instant messaging controls described herein may be performed in real time to allow prompt regulation of times during which instant messages may be received to allow intended recipients to stay on task for work or other purposes. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

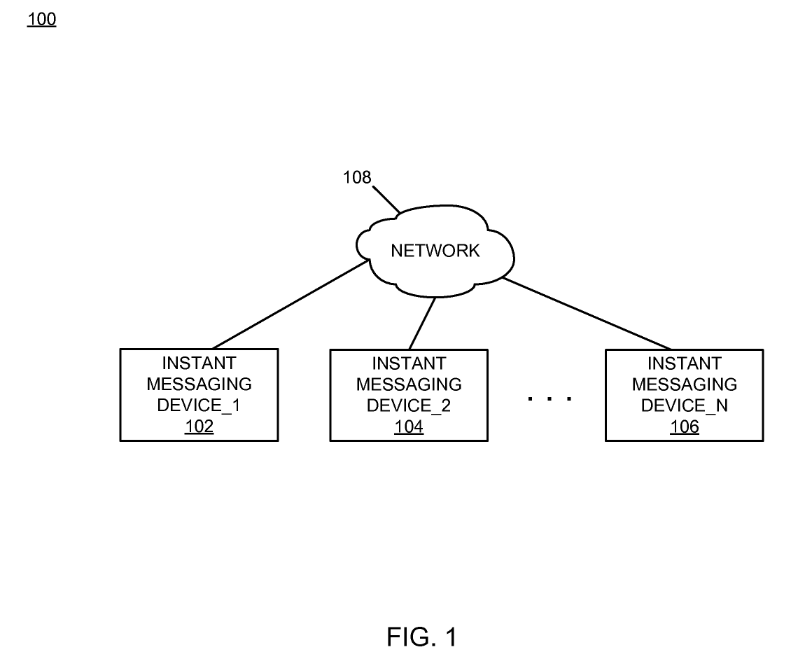

FIG. 1 is a block diagram of an example of an implementation of a system 100 for automated calendar-based instant messaging controls. An instant messaging device_1 102 interconnects with an instant messaging device_2 104 up to an instant messaging device_N 106 via a network 108. The instant messaging device_1 102 or any of the instant messaging device_2 104 through the instant messaging device_N 106 may be configured to operate based upon the subject matter described herein to perform automated calendar-based instant messaging controls. As such, for brevity, the instant messaging device_1 102 shall be referenced within the following description with the understanding that the description below applies at least equally to any such instant messaging device.

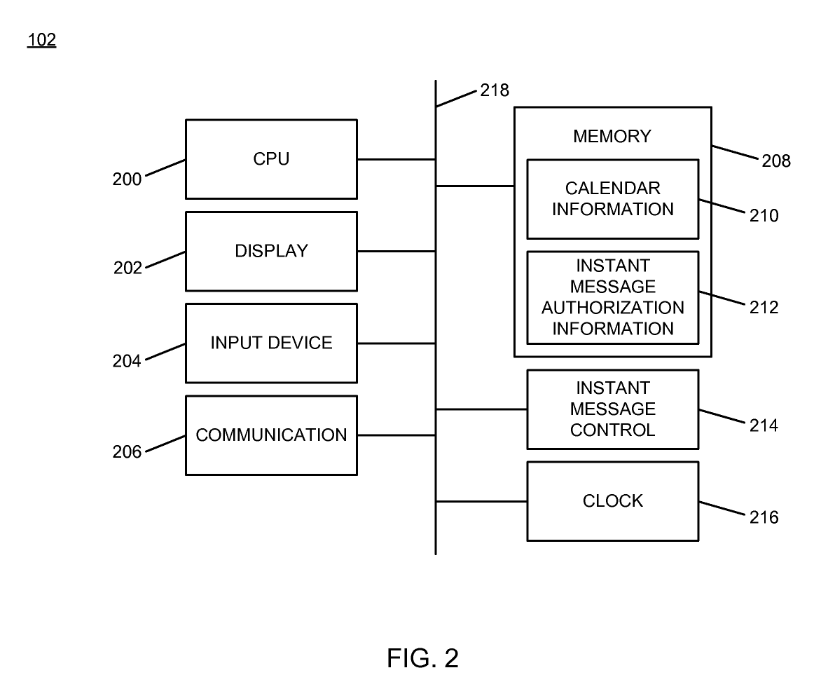

As will be described in more detail below in association with FIGS. 2 through 5, the instant messaging device_1 102 provides calendar-based instant messaging controls in an automated manner based upon configured calendar information for a user of the instant messaging device_1 102. The automated calendar-based instant messaging controls provided by the instant messaging device_1 102 permit the user of the instant messaging device_1 102 to associate configured calendar events with authorizations for user accounts associated with other instant messaging devices, such as the instant messaging device_2 104 through the instant messaging device_N 106. The associations defined between the configured calendar events and the authorizations for user accounts associated with other instant messaging devices allow the instant messaging device_1 102 to automatically process incoming instant messages according to the defined associations, as described in more detail below.

It should be noted that the instant messaging device_1 102 may be a portable computing device, either by a user's ability to move the instant messaging device_1 102 to different locations, or by the instant messaging device_1 102's association with a portable platform, such as a plane, train, automobile, or other moving vehicle. It should also be noted that the instant messaging device_1 102 may be any computing device capable of processing information as described above and in more detail below. For example, the instant messaging device_1 102 may include devices such as a personal computer (e.g., desktop, laptop, palm, etc.) or a handheld device (e.g., cellular telephone, personal digital assistant (PDA), email device, music recording or playback device, etc.), or any other device capable of processing information as described in more detail below.

The network 108 may include any form of interconnection suitable for the intended purpose, including a private or public network such as an intranet or the Internet, respectively, direct inter-module interconnection, dial-up, wireless, or any other interconnection mechanism capable of interconnecting the respective devices.

FIG. 2 is a block diagram of an example of an implementation of the instant messaging device_1 102 that is capable of performing automated calendar-based instant messaging controls. A central processing unit (CPU) 200 provides computer instruction execution, computation, and other capabilities within the instant messaging device_1 102. A display 202 provides visual information to a user of the instant messaging device_1 102 and an input device 204 provides input capabilities for the user.

The display 202 may include any display device, such as a cathode ray tube (CRT), liquid crystal display (LCD), light emitting diode (LED), projection, touchscreen, or other display element or panel. The input device 204 may include a computer keyboard, a keypad, a mouse, a pen, a joystick, or any other type of input device by which the user may interact with and respond to information on the display 202.

A communication module 206 provides interconnection capabilities that allow the instant messaging device_1 102 to communicate with other modules within the system 100, such as the instant messaging device_2 104 through the instant messaging device_N 106, to perform automated calendar-based instant messaging controls. The communication module 206 may include any electrical, protocol, and protocol conversion capabilities useable to provide the interconnection capabilities. Though the communication module 206 is illustrated as a component-level module for ease of illustration and description purposes, it should be noted that the communication module 206 may include any hardware, programmed processor(s), and memory used to carry out the functions of the communication module 206 as described above and in more detail below. For example, the communication module 206 may include additional controller circuitry in the form of application specific integrated circuits (ASICs), processors, antennas, and/or discrete integrated circuits and components for performing communication and electrical control activities associated with the communication module 206. Additionally, the communication module 206 may include interrupt-level, stack-level, and application-level modules as appropriate. Furthermore, the communication module 206 may include any memory components used for storage, execution, and data processing for performing processing activities associated with the communication module 206. The communication module 206 may also form a portion of other circuitry described without departure from the scope of the present subject matter.

A memory 208 includes a calendar information storage area 210 that stores calendar information that may be associated with a calendar management application (not shown) that is used by a user of the instant messaging device_1 102. As such, the calendar information storage area 210 stores calendar event information, such as time periods or time frames and associated activities that the user has planned for the respective time frames. As will be described in more detail below, calendar information stored within the calendar information storage area 210 is used to determine calendar events associated with a recipient of an instant message associated with a time period during which the instant message is received.

The memory 208 also includes an instant message authorization information storage area 212 that stores authorization information for user accounts associated with other instant messaging devices, such as the instant messaging device_2 104 through the instant messaging device_N 106. The instant message authorization information may be entered by a user of the instant messaging device_1 102 via the input device 204 and stored within the instant message authorization information storage area 212. The instant message authorization information may include, for example, authorization information that associates user account information for the respective other instant messaging devices with calendar event information stored within the calendar information storage area 210. Received instant messages are processed based upon the configured calendar event for the recipient and the authorization information associated with the sender of the instant message, as described in more detail below.

It is understood that the memory 208 may include any combination of volatile and non-volatile memory suitable for the intended purpose, distributed or localized as appropriate, and may include other memory segments not illustrated within the present example for ease of illustration purposes. For example, the memory 208 may include a code storage area, a code execution area, and a data area without departure from the scope of the present subject matter.

An instant message control module 214 is also illustrated. The instant message control module 214 provides the automated calendar-based instant messaging controls for the instant messaging device_1 102, as described above and in more detail below. The instant message control module 214 may perform the automated calendar-based instant messaging controls for the instant messaging device_1 102 in response to receipt of instant messages from the respective other instant messaging devices that are addressed to a recipient associated with the instant messaging device_1 102.

Though the instant message control module 214 is illustrated as a component-level module for ease of illustration and description purposes, it should be noted that the instant message control module 214 may include any hardware, programmed processor(s), and memory used to carry out the respective functions of these modules as described above and in more detail below. For example, the instant message control module 214 may include additional controller circuitry in the form of application specific integrated circuits (ASICs), processors, and/or discrete integrated circuits and components for performing communication and electrical control activities associated with the respective devices. Additionally, the instant message control module 214 may include interrupt-level, stack-level, and application-level modules as appropriate. Furthermore, the instant message control module 214 may include any memory components used for storage, execution, and data processing for performing processing activities associated with the respective modules.

It should also be noted that the instant message control module 214 may form a portion of other circuitry described without departure from the scope of the present subject matter. Further, the instant message control module 214 may alternatively be implemented as an application stored within the memory 208. In such an implementation, the instant message control module 214 may include instructions executed by the CPU 200 for performing the functionality described herein. The CPU 200 may execute these instructions to provide the processing capabilities described above and in more detail below for the instant messaging device_1 102. The instant message control module 214 may form a portion of an interrupt service routine (ISR), a portion of an operating system, a portion of a browser application, or a portion of a separate application without departure from the scope of the present subject matter.

A clock 216 is associated with the instant messaging device_1 102 and provides timing capabilities and calendar capabilities for the instant messaging device_1 102. As such, the clock 216 may include a real-time clock that provides as output a time, date, and other information for use by the instant message control module 214 for automated calendar-based instant messaging controls.

The CPU 200, the display 202, the input device 204, the communication module 206, the memory 208, the instant message control module 214, and the clock 216 are interconnected via an interconnection 218. The interconnection 218 may include a system bus, a network, or any other interconnection capable of providing the respective components with suitable interconnection for the respective purpose.

While the instant messaging device_1 102 is illustrated with and has certain components described, other modules and components may be associated with the instant messaging device_1 102 without departure from the scope of the present subject matter. Additionally, it should be noted that, while the instant messaging device_1 102 is described as a single device for ease of illustration purposes, the components within the instant messaging device_1 102 may be co-located or distributed and interconnected via a network without departure from the scope of the present subject matter. For a distributed arrangement, the display 202 and the input device 204 may be located at a kiosk or other location, while the CPU 200 and memory 208 may be located at a local or remote server. Many other possible arrangements for components of the instant messaging device_1 102 are possible and all are considered within the scope of the present subject matter. Accordingly, the instant messaging device_1 102 may take many forms and may be associated with many platforms.

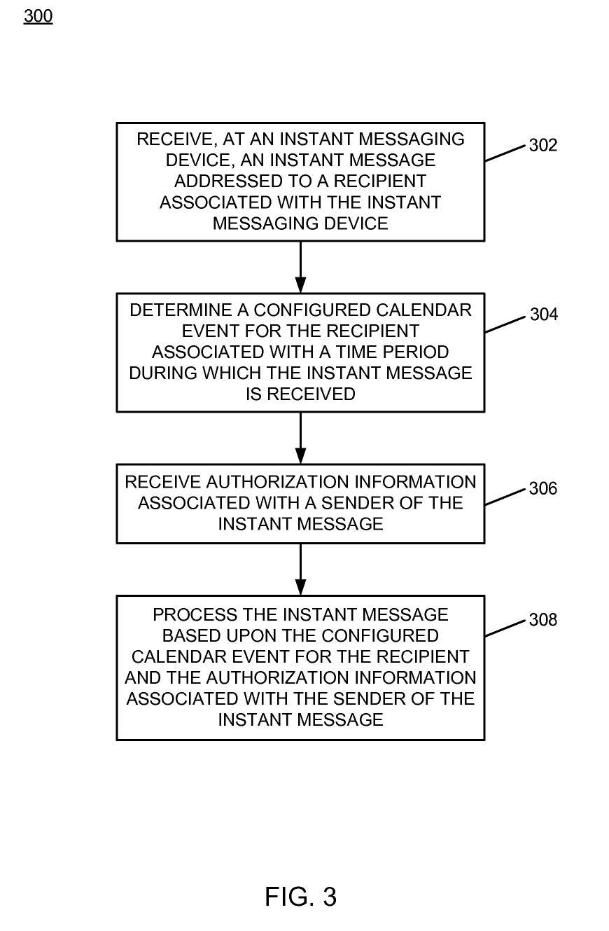

FIG. 3 through FIG. 5 below describe example processes that may be executed by devices, such as the instant messaging device_1 102, to perform the automated control of instant messaging based upon calendar information associated with the present subject matter. Many other variations on the example processes are possible and all are considered within the scope of the present subject matter. The example processes may be performed by modules, such as the instant message control module 214 and/or executed by the CPU 200, associated with such devices. It should be noted that time out procedures and other error control procedures are not illustrated within the example processes described below for ease of illustration purposes. However, it is understood that all such procedures are considered to be within the scope of the present subject matter.

FIG. 3 is a flow chart of an example of an implementation of a process 300 for automated calendar-based instant messaging controls. At block 302, the process 300 receives, at an instant messaging device, an instant message addressed to a recipient associated with the instant messaging device. At block 304, the process 300 determines a configured calendar event for the recipient associated with a time period during which the instant message is received. At block 306, the process 300 receives authorization information associated with a sender of the instant message. At block 308, the process 300 processes the instant message based upon the configured calendar event for the recipient and the authorization information associated with the sender of the instant message.

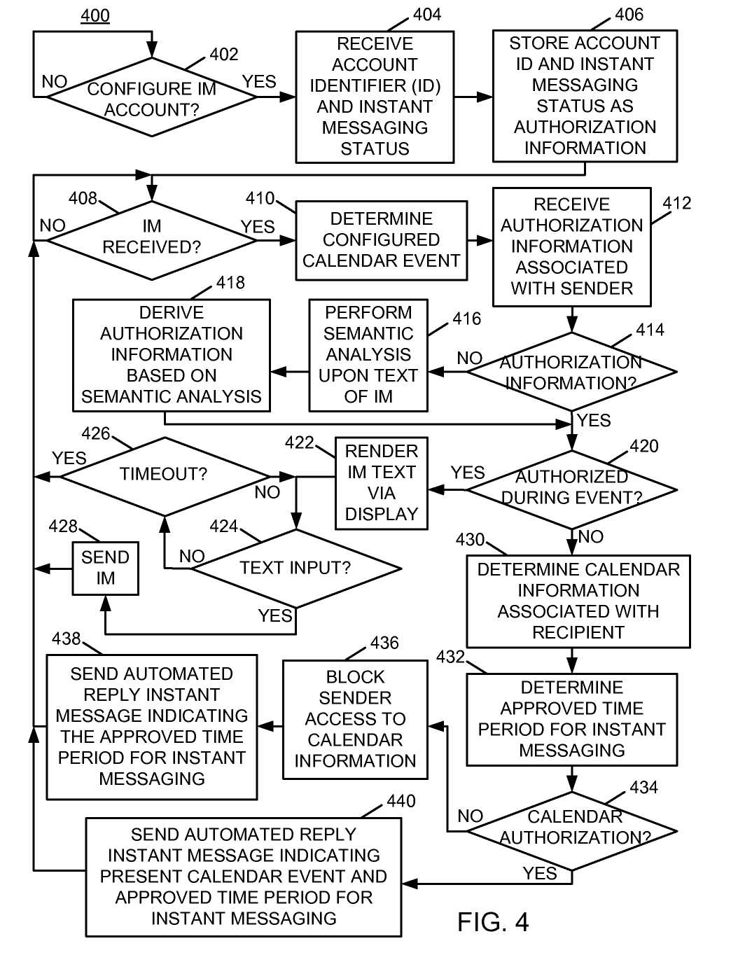

FIG. 4 is a flow chart of an example of an implementation of a process 400 for configuring an instant message account for automated calendar-based instant messaging controls. At decision point 402, the process 400 makes a determination as to whether a request to configure an instant message (IM) user account has been detected. A request to configure an IM user account may be detected, for example, by detection of inputs via the input device 204 associated with the instant messaging device_1 102.

When a determination is made that a request to configure an IM user account has been detected, the process 400 receives an account identifier (ID) and an instant messaging status associated with the account ID at block 404. At block 406, the process 400 stores the account identifier and the instant messaging status associated with the IM user account as authorization information associated with IM user account, such as to the instant message authorization information storage area 212.

At decision point 408, the process 400 makes a determination as to whether an IM has been received. The process 400 iterates at decision point 408 until receipt of an instant message has been detected, such as via the communication module 206. When a determination is made that an instant message has been received, the process 400 determines a configured calendar event for the recipient associated with a time period during which the instant message is received, such as via calendar information stored the calendar information storage area 210, at block 410. Additionally, the process 400 may query a calendar application (not shown) associated with the instant messaging device_1 102 for a configured calendar event that is scheduled concurrently with the time period during which the instant message is received. At block 412, the process 400 receives authorization information associated with a sender of the instant message, such from the instant message authorization information storage area 212.

At decision point 414, the process 400 makes a determination as to whether authorization information associated with the sender of the instant message has been previously configured. When a determination is made that no authorization information associated with the sender of the instant message has been previously configured, the process 400 performs a semantic analysis upon text associated with the received instant message at block 416 and derives the authorization information based upon the semantic analysis of the text associated with the received instant message at block 418. As such, the process 400 performs a semantic analysis in the absence of previously configured authorization information to further assist the user of the instant messaging device_1 102 by automatically filtering instant messages received from user accounts other than previously configured user accounts having configured authorization information. The semantic analysis may, for example, search for a project name or other information within the text of the received instant message to determine whether the project name matches or is similar to a configured calendar event in the form of a project name. Many other possibilities exist for semantic analysis of received instant messages and all are considered within the scope of the present subject matter.

Upon completion of semantic analysis of the received instant message at block 418 or upon making a determination that authorization information associated with the sender of the instant message has been previously configured at decision point 414, the process 400 makes a determination at decision point 420 as to whether the sender is authorized to send instant messages to the instant messaging device_1 102 during time periods associated with the configured calendar event. When a determination is made that the sender is authorized to send instant messages to the instant messaging device_1 102 during time periods associated with the configured calendar event, the process 400 renders the instant message text associated with the instant message via a display, such as the display 202, associated with the instant messaging device_1 102 at block 422.

At decision point 424, the process 400 makes a determination as to whether text input has been detected, such as via the input device 204. When a determination is made that no text input has been detected, the process 400 makes a determination as to whether a timeout for text input has occurred, such as by inspection of elapsed time using the clock 216, at decision point 426.

When a determination is made at decision point 426 that a timeout for text input has been detected, the process 400 returns to decision point 408 and iterates as described above. When a determination is made at decision point 426 that a timeout for text input has not been detected, the process 400 returns to decision point 424 to determine whether any text input has been detected. When a determination is made that text input has been detected, the process 400 sends an instant message at block 428 and returns decision point 408 and iterates as described above. It is understood that multiple iterations of text input may occur to complete text input for an instant message. However, this addition processing is not illustrated within FIG. 4 for ease of illustration purposes.

Returning to the description of decision point 420, when a determination is made that the sender is not authorized to send instant messages to the instant messaging device_1 102 during time periods associated with the configured calendar event, the process 400 determines calendar information associated with the recipient at block 430. At block 432, the process 400 determines an approved time period during which the sender is authorized to send instant messages to the instant messaging device_1 102 based upon the calendar information.

At decision point 434, the process 400 makes a determination as to whether the sender of the received instant message is authorized to receive information associated with the configured calendar event for the user of the instant messaging device_1 102. The process 400 may, for example, receive a hierarchical list of persons authorized to receive calendar information associated with the recipient, such as from the instant message authorization information storage area 212. The process 400 may further determine whether the sender is listed within the hierarchical list as a person authorized to receive the calendar information associated with the recipient. The hierarchical list may further include at least one group of persons at a level of the hierarchical list of persons that is authorized to receive the calendar information associated with the recipient. In such a situation, the process 400 may determine whether the sender is a member of the group.

When a determination is made at decision point 434 that the sender is not authorized to receive information associated with the configured calendar event, the process 400 blocks access by the sender to calendar information associated with the recipient at block 436. At block 438, the process 400 sends an automated reply instant message to a device, such as one of the instant messaging device_2 104 through the instant messaging device_N 106, associated with the sender of the received instant message indicating the approved time period during which the sender is authorized to send instant messages to the instant messaging device. The process 400 returns to decision point 408 and iterates as described above.

In this manner, the process 400 may alert the sender of an authorized time period during which to send an instant message without divulging calendar information associated with the presently-calendared event. For example, where the sender is a colleague with a different security clearance or where the sender is associated with a different project and may take issue with the recipient working on a project other than the sender's project, the process 400 blocks distribution of calendar information associated with the presently-calendared event.

Returning to the description of decision point 434, when a determination is made that the sender is authorized to receive information associated with the configured calendar event, the process 400 sends an automated reply instant message to the device associated with the sender including information associated with the configured calendar event at block 440. In this manner, the process 400 may distribute configured calendar event information to approved user accounts associated with respective other devices. For example, where the sender is a manager of the recipient of the instant message or where the sender has appropriate security clearance, the process 400 may send the information associated with the configured calendar event to the sender. The process 400 then returns to decision point 408 and iterates as described above.

As such, the process 400 provides for configuration of authorization information for instant messages received from user accounts associated with other instant messaging devices. The process 400 processes received instant messages based upon configured calendar event for the recipient and the authorization information associated with the sender of the instant message. The process 400 blocks distribution of calendar event information or distributes the calendar event information based upon authorization for distribution of the calendar event information.

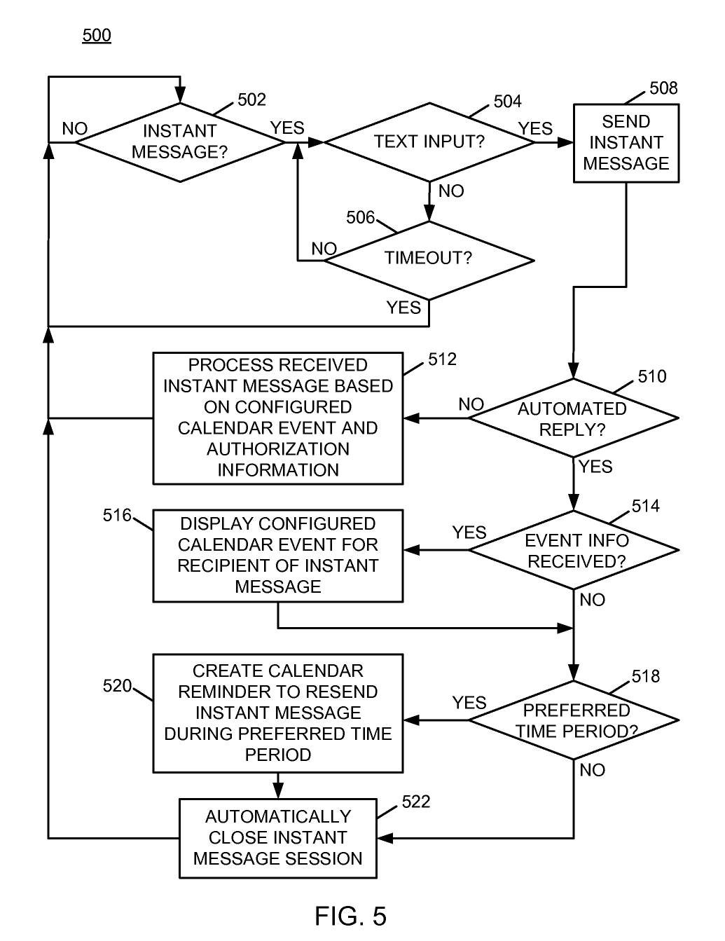

FIG. 5 is a flow chart of an example of an implementation of a process 500 for sending an instant message and performing automated calendar-based instant messaging controls in response to automated calendar-based instant messaging controls implemented by the receiving device. At decision point 502, the process 500 makes a determination as to whether a request has been detected, such as via the input device 204, to generate an instant message. When a determination is made that a request to generate an instant message has been detected, the process 500 makes a determination as to whether text input for the message has been completed at decision point 504. When a determination is made that text input for the message has not been completed, the process 500 makes a determination as to whether a timeout for text input has occurred, such as by inspection of elapsed time using the clock 216, at decision point 506.

When a determination is made at decision point 506 that a timeout for text input has been detected, the process 500 returns to decision point 502 and iterates as described above. When a determination is made at decision point 506 that a timeout for text input has not been detected, the process 500 returns to decision point 504 to determine whether text input has been completed. When a determination is made at decision point 504 that text input has been completed, the process 500 sends the formed instant message at block 508.

At decision point 510, the process 500 makes a determination as to whether an automated reply or whether another instant message other than an automated reply has been received from the device to which the instant message has been sent. When a determination is made that another instant message other than an automated reply has been received, the process 500 processes the received instant message based upon configured calendar event and authorization information at block 512, such as for example, by processing similar to that described above in association with FIG. 4. The process 500 returns to decision point 502 to await detection of a request to generate an instant message.

When a determination is made at decision point 510 that an automated reply has been received from the device to which the instant message has been sent, the process 500 makes a determination as to whether configured calendar event information has been received in association with the automated reply at decision point 514. When a determination is made that configured calendar event information has been received in association with the automated reply, the process 500 displays the configured calendar event information, such as via the display 202, at block 516.

Upon completion of displaying any received configured calendar event information at block 516 or upon determining at decision point 514 that configured calendar event information has not been received in association with the automated reply, the process 500 makes a determination as to whether a preferred time period has been received in association with the automated reply at decision point 518. For example, as described above, an automated reply may include an indication of another time period that is preferred by the recipient associated with the other instant messaging device for instant message communications.

When a determination is made that a preferred time period has been received in association with the automated reply, the process 500 creates a calendar reminder to resend the instant message during the preferred time period at block 520. Upon completion of creation of the calendar reminder to resend the instant message during the preferred time period or upon determining at decision point 518 that a preferred time period not has been received in association with the automated reply, the process 500 automatically closes an instant message session in response to receipt of the automated reply at block 522 and returns to decision point 502 to await detection of a request to generate an instant message.

As such, the process 500 provides automated calendar-based instant messaging controls based upon requests to send instant messages to other instant messaging devices. The process 500 processes received automated replies generated by the respective other instant messaging devices and creates calendar reminders to resend an instant message if the recipient is occupied during the time period associated with sending the instant message. The process 500 also displays any received configured calendar information associated with the recipient of the instant message, when the sender is authorized to receive such information, in response to receipt of an automated reply instant message.

As described above in association with FIG. 1 through FIG. 5, the example systems and processes provide automated calendar-based instant messaging controls. Many other variations and additional activities associated with automated calendar-based instant messaging controls are possible and all are considered within the scope of the present subject matter.

Those skilled in the art will recognize, upon consideration of the above teachings, that certain of the above examples are based upon use of a programmed processor, such as the CPU 200. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
receiving, at an instant messaging device, an instant message addressed to a recipient associated with the instant messaging device;
determining a configured calendar event for the recipient associated with a time period during which the instant message is received;
receiving authorization information associated with a sender of the instant message; and
processing the instant message based upon the configured calendar event for the recipient and the authorization information associated with the sender of the instant message.

2. The method of claim 1, wherein processing the instant message based upon the configured calendar event for the recipient and the authorization information associated with the sender of the instant message comprises:
determining whether the sender is authorized to send instant messages to the recipient associated with the instant messaging device during time periods associated with the configured calendar event; and
providing instant message text associated with the instant message to the instant messaging device upon determining that the sender is authorized to send instant messages during the time periods associated with the configured calendar event.

3. The method of claim 2, further comprising:
upon determining that the sender is not authorized to send instant messages to the recipient instant messaging device during the time periods associated with the configured calendar event:
determining calendar information associated with the recipient;
determining an approved time period during which the sender is authorized to send instant messages to the recipient associated with the instant messaging device based upon the calendar information; and
sending an automated reply instant message to an instant messaging device associated with the sender indicating the approved time period during which the sender is authorized to send instant messages to the recipient associated with the instant messaging device.

4. The method of claim 3, further comprising:
determining whether the sender of the received instant message is authorized to receive information associated with the configured calendar event; and
wherein sending the automated reply instant message to the instant messaging device associated with the sender comprises:
upon determining that the sender is authorized to receive the information associated with the configured calendar event, sending the information associated with the configured calendar event; and
upon determining that the sender is not authorized to receive the information associated with the configured calendar event, blocking access by the sender to the calendar information associated with the recipient.

5. The method of claim 4, wherein determining whether the sender is authorized to receive the information associated with the configured calendar event comprises:
receiving a hierarchical list of persons authorized to receive the calendar information associated with the recipient; and
determining whether the sender is listed within the hierarchical list as a person authorized to receive the calendar information associated with the recipient.

6. The method of claim 1, further comprising:
sending an instant message addressed to a recipient associated with another instant messaging device;
receiving an automated reply indicating another time period that is preferred by the recipient associated with the other instant messaging device for instant message communications;
automatically closing an instant message session in response to receipt of the automated reply; and
creating a calendar reminder to resend the instant message to the recipient associated with the other instant messaging device during the preferred time period.

7. The method of claim 1, further comprising:
upon determining that the authorization information associated with the sender of the instant message does not comprise calendar authorization information:
performing semantic analysis upon text associated with the received instant message; and
deriving the authorization information based upon the semantic analysis of the text associated with the received instant message.

8. A system, comprising:
a memory; and
a processor programmed to:
receive an instant message addressed to a recipient;
determine a configured calendar event for the recipient associated with a time period during which the instant message is received;
receive authorization information from the memory associated with a sender of the instant message; and
process the instant message based upon the configured calendar event for the recipient and the authorization information associated with the sender of the instant message.

9. The system of claim 8, further comprising:
a display; and
wherein, in being programmed to process the instant message based upon the configured calendar event for the recipient and the authorization information associated with the sender of the instant message, the processor is programmed to:
determine whether the sender is authorized to send instant messages to the recipient during time periods associated with the configured calendar event; and
provide instant message text associated with the instant message to the instant messaging device upon determining that the sender is authorized to send instant messages during the time periods associated with the configured calendar event.

10. The system of claim 9, wherein the processor is further programmed to:
upon determining that the sender is not authorized to send instant messages to the recipient during the time periods associated with the configured calendar event:
determine calendar information associated with the recipient;
determine an approved time period during which the sender is authorized to send instant messages to the recipient based upon the calendar information; and
send an automated reply instant message to an instant messaging device associated with the sender indicating the approved time period during which the sender is authorized to send instant messages to the recipient.

11. The system of claim 10, wherein the processor is further programmed to:
determine whether the sender of the received instant message is authorized to receive information associated with the configured calendar event; and
wherein, in being programmed to send the automated reply instant message to the instant messaging device associated with the sender, the processor is programmed to:
upon determining that the sender is authorized to receive the information associated with the configured calendar event, send the information associated with the configured calendar event; and
upon determining that the sender is not authorized to receive the information associated with the configured calendar event, block access by the sender to the calendar information associated with the recipient.

12. The system of claim 8, wherein the processor is further programmed to:
send an instant message addressed to a recipient associated with another instant messaging device;
receive an automated reply indicating another time period that is preferred by the recipient associated with the other instant messaging device for instant message communications;
automatically close an instant message session in response to receipt of the automated reply; and
create a calendar reminder to resend the instant message to the recipient associated with the other instant messaging device during the preferred time period.

13. The system of claim 8, wherein the processor is further programmed to:
upon determining that the authorization information associated with the sender of the instant message does not comprise calendar authorization information:
perform semantic analysis upon text associated with the received instant message; and
derive the authorization information based upon the semantic analysis of the text associated with the received instant message.

14. A computer program product, comprising:
a computer readable storage medium having computer readable program code embodied therewith, the computer readable program code comprising:
computer readable program code configured to receive an instant message addressed to a recipient;
computer readable program code configured to determine a configured calendar event for the recipient associated with a time period during which the instant message is received;
computer readable program code configured to receive authorization information associated with a sender of the instant message; and
computer readable program code configured to process the instant message based upon the configured calendar event for the recipient and the authorization information associated with the sender of the instant message.

15. The computer program product of claim 14, wherein the computer readable program code configured to process the instant message based upon the configured calendar event for the recipient and the authorization information associated with the sender of the instant message comprises:
computer readable program code configured to determine whether the sender is authorized to send instant messages to the recipient during time periods associated with the configured calendar event; and
computer readable program code configured to provide instant message text associated with the instant message to the instant messaging device upon determining that the sender is authorized to send instant messages during the time periods associated with the configured calendar event.

16. The computer program product of claim 15, further comprising:
upon determining that the sender is not authorized to send instant messages to the recipient during the time periods associated with the configured calendar event:
computer readable program code configured to determine calendar information associated with the recipient;
computer readable program code configured to determine an approved time period during which the sender is authorized to send instant messages to the recipient based upon the calendar information; and
computer readable program code configured to send an automated reply instant message to an instant messaging device associated with the sender indicating the approved time period during which the sender is authorized to send instant messages to the recipient.

17. The computer program product of claim 16, further comprising:
computer readable program code configured to determine whether the sender of the received instant message is authorized to receive information associated with the configured calendar event; and
wherein the computer readable program code configured to send the automated reply instant message to the instant messaging device associated with the sender comprises:
computer readable program code configured to, upon determining that the sender is authorized to receive the information associated with the configured calendar event, send the information associated with the configured calendar event; and
computer readable program code configured to, upon determining that the sender is not authorized to receive the information associated with the configured calendar event, block access by the sender to the calendar information associated with the recipient.

18. The computer program product of claim 17, wherein the computer readable program code configured to determine whether the sender is authorized to receive the information associated with the configured calendar event comprises:
computer readable program code configured to receive a hierarchical list of persons authorized to receive the calendar information associated with the recipient; and
computer readable program code configured to determine whether the sender is listed within the hierarchical list as a person authorized to receive the calendar information associated with the recipient.

19. The computer program product of claim 14, further comprising:
computer readable program code configured to send an instant message addressed to a recipient associated with another instant messaging device;
computer readable program code configured to receive an automated reply indicating another time period that is preferred by the recipient associated with the other instant messaging device for instant message communications;
computer readable program code configured to automatically close an instant message session in response to receipt of the automated reply; and
computer readable program code configured to create a calendar reminder to resend the instant message to the recipient associated with the other instant messaging device during the preferred time period.

20. The computer program product of claim 14, further comprising:
upon determining that the authorization information associated with the sender of the instant message does not comprise calendar authorization information:
computer readable program code configured to perform semantic analysis upon text associated with the received instant message; and
computer readable program code configured to derive the authorization information based upon the semantic analysis of the text associated with the received instant message.
